(19) United States
(12) Patent Application Publication
(10) Pub. No.: US 2010/0161689 A1
(43) Pub. Date: Jun. 24, 2010

(54) METHOD OF UPDATING/MODIFYING A STAND ALONE NON-NETWORK CONNECTIBLE DEVICE

(75) Inventors: Cunsheng Vincent Dong, Singapore (SG); Yovita Sulaiman Lai, Singapore (SG); Kok Ghay Wong, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd., Singapore (SG)

(21) Appl. No.: 12/342,810

(22) Filed: Dec. 23, 2008

(51) Int. Cl. G06F 9/00; G06F 7/06; G06F 17/30

(52) U.S. Cl. 707/821; 713/100; 707/E17.014

(57) ABSTRACT

A method and system is disclosed for updating/modifying/upgrading the system configuration of a stand alone non-network connectible device. The method is performed while a portable device is docked to the non-network connectible device. System configuration update information is embedded within the ordinary data content that is received from the portable device during the routine operation of the stand alone non-network connectible device. Upon receiving the embedded system configuration update information the non-network connectible device decrypts the embedded information and updates the system configuration accordingly. Generation of the embedded system configuration update information is performed in the portable docking device, and installation is performed on the non-network connectible device without requiring a network connection in the stand alone device.

### FIELD OF THE INVENTION

This invention relates generally to a method of updating/modifying a system configuration within a stand alone non-network connectible device by docking a portable device to the non-network connectible device. More particularly, this invention relates to a method of embedding update/modification system configuration information within the ordinary data content that is received from the portable device for the routine operation of the stand alone non-network connectible device.

### BACKGROUND

There is a demand for peripheral devices and accessories for portable media players because of the voluminous sales of the portable media players. Such peripheral devices include docking speaker systems, docking mixing consoles, and the like. The peripheral devices typically have a port for receiving a portable media player. Often, the peripheral devices are conceived as stand alone non-network connectible devices meaning that the peripheral device lacks a port and/or input/output (I/O) interface for accessing a network. Such peripheral devices are typically designed with a single port that is arranged for exclusively receiving and docking with a particular brand or model of portable media player. In order to save on component costs and expense, these peripheral docking devices are often not designed with any networking capability.

Users of portable media devices are often provided with an option(s) to upgrade and update the system configuration of their existing portable media player. The upgrades are typically provided by the media player manufacturer and provide new enhancements and features. Also, users may replace an application providing media player functionality on their existing portable media player for a different media player application provided by a different media player company. However, this may lead to a situation where the system configuration of the peripheral device and the modified portable media player may not be compatible to one another. There is no current way of easily and cost effectively upgrading/updating/modifying such out of date conventional peripheral docking devices.

In addition, an accelerated rate of product development for the portable media devices to meet ever-changing tastes of consumers has led to a situation where accompanying peripheral devices and accessories also need to be developed at the same accelerated rate. This has invariably led to underdeveloped/imperfect peripheral devices and accessories being released into the market because of the time pressures. It would be detrimental to consumers if the underdeveloped/imperfect peripheral devices and accessories are not able to be properly developed/improved subsequent to the market launch, especially when all which is required is merely modification of on-device software determining a configuration of the peripheral devices and accessories.

There is thus a need to provide a method of updating the system configuration of a stand alone non-network connectible device.

### SUMMARY

An aspect of the invention is a method for updating a system configuration of a stand alone non-network connectible device comprises providing a portable device for communicating with the non-network connectible device; generating a media file comprising embedded update content within a data container of the media file, the update content for updating the system configurations of the non-network connectible device; receiving the media file comprising the embedded update content at the non-network connectible device; and installing the update content to update the system configuration of the non-network connectible device.

An aspect of the invention is a method for either updating or modifying a system configuration of a stand alone non-network connectible device comprises providing a portable device for communicating with the non-network connectible device; generating a media file comprising embedded update content within a data container of the media file, the configuration content for either updating or modifying the system configurations of the non-network connectible device; receiving the media file comprising the embedded configuration content at the non-network connectible device; and installing the update content to either update or modify the system configuration of the non-network connectible device.

In an embodiment, the method may further comprise writing the embedded configuration content in the media file into a corresponding address within a memory of the non-network connectible device. The method may further comprise triggering by a user's action the installing the configuration content to update the system configuration of the non-network connectible device. The method may further comprise searching the portable device for a media file with the embedded configuration content, selecting and playing the media file with the embedded configuration content.

In an embodiment, the media file may be a file with an associated information tag. The data container may be an ID3 tag. The generating the media file comprising embedded configuration content may further comprise generating at least one media file, each media file having a portion of the embedded configuration content within a data container of each media file. The method may further comprise assigning to another track tag data container different characters to identify the correct order of the portion update content in the at least two media files.

In an embodiment the generating of the media file comprising embedded configuration content may further comprise naming another data container of the media file with a name representative of the update content. The another data container may be a title tag. The method may further comprise connecting the portable device to a docking port of the non-network connectible device, the connection being either wired or wireless. The data container may be a lyric tag. The method may further comprise formatting the configuration content in Intel HEX file format. The method may further comprise encrypting the configuration content. The installing of the configuration content to update the system configuration of the non-network connectible device may further comprise rebooting the non-network connectible device. The media file may be of the same type that is ordinarily received from the portable device in the routine operation of the stand alone non-network connectible device.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is a system block diagram of a stand alone non-network connectible device and a portable device docking system in accordance with an embodiment of the invention;

FIG. 2 is a schematic diagram illustrating data strings of information containing media content and update content in accordance with an embodiment of the invention;

FIG. 3A-B show graphical user interfaces (GUI) screen shots showing files containing update content in accordance with an embodiment of the invention;

FIG. 4 is a flow chart of a method of generating the embedded files containing update content in accordance with an embodiment of the invention; and

FIG. 5 is a flow chart of a method of installing the update content in the stand alone non-network connectible device in accordance with an embodiment of the invention.

### DETAILED DESCRIPTION

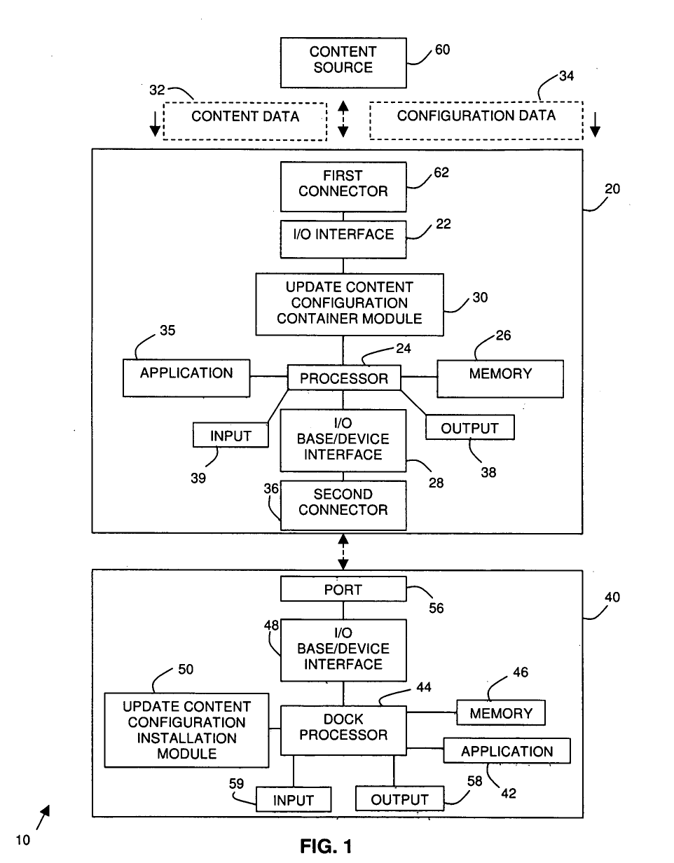

A method and system is disclosed for updating/modifying system configurations of a stand alone non-network connectible device. FIG. 1 shows a system 10 in accordance with an embodiment of the invention. The system 10 comprises a stand alone non-network connectible device or base device 40 and a portable device 20. The portable device 20 docks with the base device 40 via portable device port 36 and base device port 56. The base device 40 is a non-network connectible device in that the port 56 is merely for docking with the portable device. The port 56 and I/O interface 48 of the base device does not allow access to any network. The port 56 may be either a proprietary connector or a standardized connector such as, for example, USB, IEEE 1394, mini-USB, and so forth.

The base device 40 comprises a dock processor 44 for controlling the system configuration of the base device 40 including for example, an update/modification content installation module 50 and other applications 42. The dock processor 44 is interconnected with an I/O base/portable device interface 48 for communicating with the portable device 20. The base device 40 may also include memory 46 for data storage. The base device 40 may be configured with output means 58 and/or input means 59. Output means 58 may include for example speakers, display, headphones or the like. Input means 59 may include for example touch screen, buttons, keyboard, microphone and the like.

The portable device 20 comprises a processor 24 for controlling the portable device system including for example applications 35, and update/modification content container module 30. The processor 24 is interconnected with I/O portable device/base interface 28 for communicating with the base device 40. The portable device 20 may also include memory 26 for storage. The portable device 20 may be configured with output means 38 and/or input means 39. Output means 38 may include for example speakers, display, headphones or the like. Input means 39 may include for example touch screen, buttons, keyboard, microphone and the like. The portable device 20 may have a first connector 62 for receiving media content from a content source 60 either via a wired or a wireless connection and communicating with the portable device 20 via I/O interface 22. The content source 60 may include, for example, a personal computer, a server, a portable computer, and the like. It will also be appreciated that a second connector 36 of the portable device 20, and the base device port 56 may be connectible either via a wired or a wireless connection.

The method is performed in a system such as the system 10 as shown in FIG. 1. The method of installation is conducted while the portable device 20 is docked to the base device 40. System configuration update information is embedded within ordinary data content that is received from the portable device 20 during the routine operation of the base device 40. Upon receiving the embedded system configuration update information the base device 40 decrypts the embedded information and updates the system configuration accordingly. Installation of the embedded system configuration update information is performed in the base device 40 without requiring a network connection in the base device 40.

In the portable device 20, the update content container module 30 receives configuration data 34 and content data 32 from the content source 60. The configuration data 34 may comprise system software update information of the base device 40. The content data 32 may be the data that is sent from the portable device 20 to the base device 40 for the routine operation of the base device 40. For example the content data 32 may be media files. An application 35 on the portable device 20 may be any application that supports the media files.

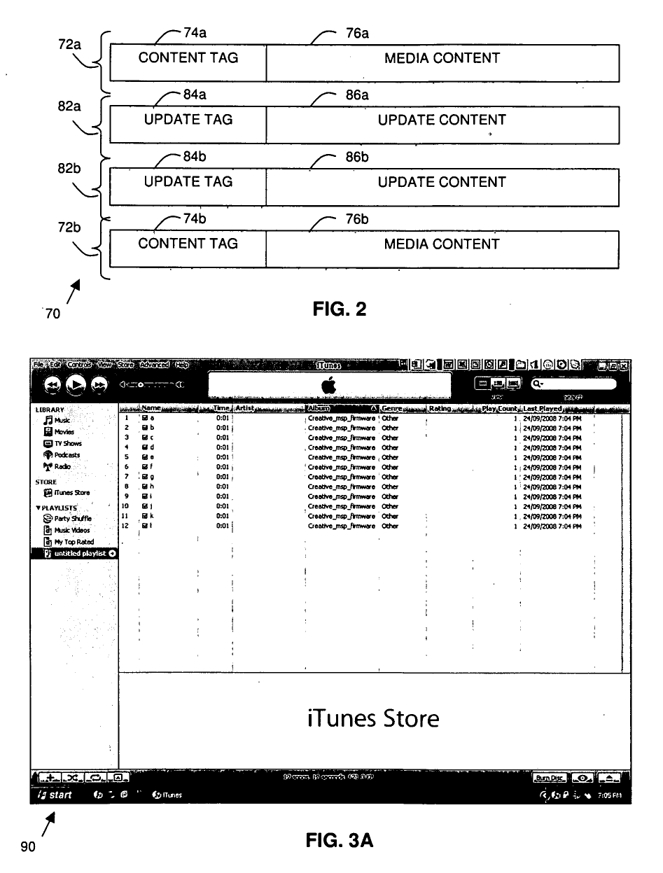

The data string of the content data 32 and the configuration data 34 is schematically shown in FIG. 2. The container module 30 receives the content data 32 and the configuration data 34 and configures and organizes data 70 in accordance with the data strings 72a,72b,82a,82b as shown in FIG. 2. The data strings comprise for example content tags or triggers 74a,74b,84a,84b with the associated media content 76a,76b or update content 86a,86b as shown.

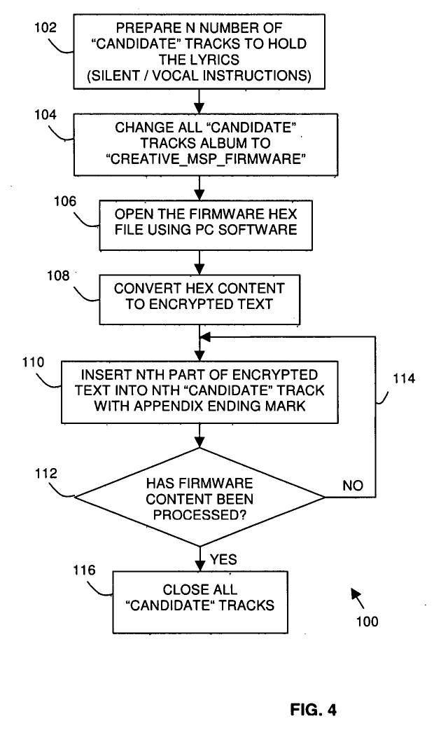

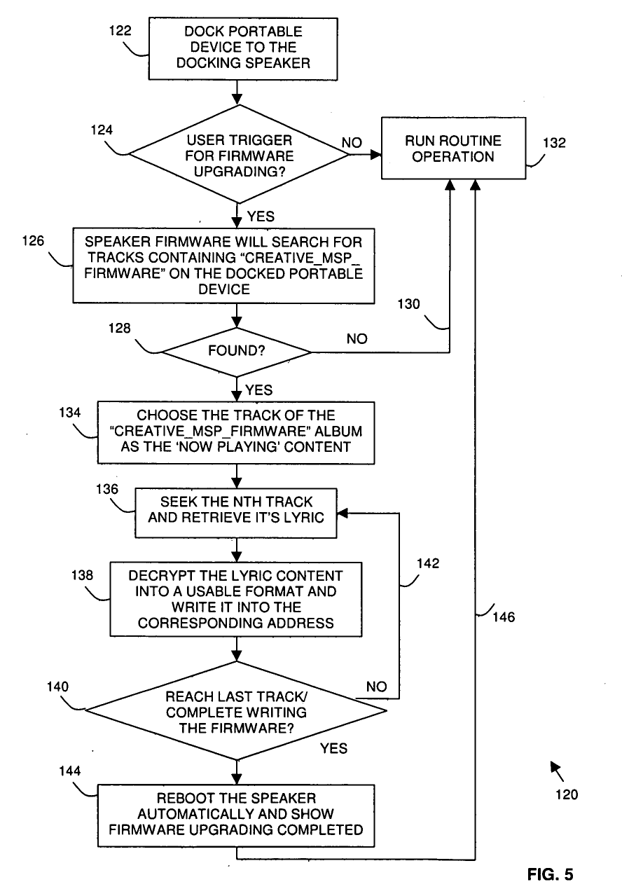

The content data 32 and the configuration data 34 may be configured in a number of different formats, such as media files, Intel HEX format, ID3 version 2 format and the like. The generation of the content data 32 and the configuration date 34 is discussed in greater detail below with reference to FIG. 4. The installation of the content data and the configuration data 34 is discussed in greater detail below with reference to FIG. 5.

In an embodiment, the configuration data 34 is firmware that is embedded into MP3 files that the portable device 20 transfers to the base device 40 during the routine operation of the base device 40. The component of the MP3 files within which the configuration data 34 is embedded is the lyric tag or component of the file of the ID3 or ID3v2 format. The tag within ID3 format in MP3 audio files typically contains the lyrics, song title, artist name, recording details, etc. It will be appreciated that other tags or components of the media file in other formats may be used. Other than MP3, other file formats may include such as for example WAV, AAC, WMA, Ogg Vorbis, or the like. The file formats that have an associated tagging format using data containers similar to ID3 are useful to embed the configuration data 34 within the audio file tagging. The configuration data 34 is contained in Intel HEX format and may be encrypted. The file content may be encrypted with a number of encryption methods and tools. It will be appreciated that while audio file formats are discussed with respect to the above embodiments, the configuration data 34 may be embedded in other types of media content files and formats.

The portable device 20 may be any type of device such as a portable MP3 player, mobile phone, personal digital assistant (PDA), laptop computer and the like that is able to transfer media content to a stand-alone non-network connectible device such as base device 40. Such portable digital MP3 players include iPod (IPOD is a registered trademark of Apple, Inc.), Zen (ZEN is a registered trademark of Creative Technology Ltd.), and the like.

The base device 40 may be any stand alone non-network connectible device that receives media content from a device such as the portable device 20. Such base devices 40 include docking systems such as docking speaker systems and the like. The base device 40 is a non-network connectable device and does not have a network connectible port that allows communication across a network. It will be appreciated that any application or configuration on any non-network connectible device may be seamlessly updated with embodiments of the invention without requiring a network connection.

The application 42 or system configuration on the base device 40 may be updated in accordance with an embodiment of the invention. The application 42 for driving the base device 40 receives the data 70 from the portable device 20 via the I/O base/device interface 48 and executes the media content of the data 70 to the output 58. The processor 44 instructs an update of the application 42 if update content 86a,86b is detected by the update tag 84a,84b within the data 70, such as the lyric tag or component.

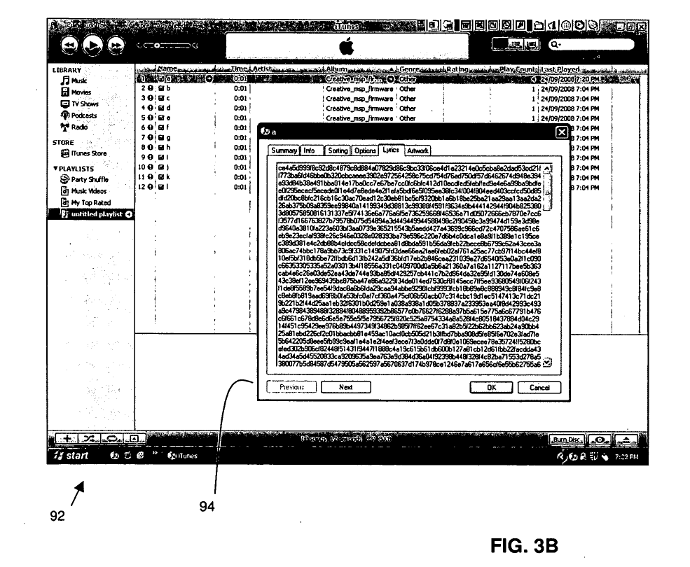

FIG. 3A and FIG. 3B show screen shots 90,92 of a graphical user interface (GUI) of ITUNES showing twelve media files (a-I) entitled “Creative_msp_firmware” as shown in FIG. 3A, which was obtained by selecting “Get Info/Lyrics” in ITUNES. The media files contain firmware for the base device 40. Each base track may be a 1 second silence track in MP3 format. FIG. 3B shows another screen shot 92 with a secondary window 94 superimposed on the screen shot of FIG. 3A. The secondary window 94 shows the firmware in an encrypted form.

FIG. 4 is a flow chart of a method 100 for generating the embedded update content into the media content (the data 70 of FIG. 2) in accordance of an embodiment of the invention. The method of generating the embedded update content media file is performed at the content source 60. The configuration data 34 is configured in a format such as Intel HEX file format. The method prepares N number of “candidate” tracks to hold the configuration data 34 in the lyrics tag or component of the data carrier of the media file 102. The configuration data 34 is also prepared accordingly with N number of corresponding parts. The configuration data 34 may be embedded in the lyrics tag as silent/vocal instructions 102. “N” is the number of the file/part. The “candidate” title of the tracks stored in another data container of the media file, for example the title tag. The title tags are changed to reflect the nature of the configuration data 34, such as for example as shown in FIG. 3A and 4 as, for example “Creative_msp_firmware” 104. The firmware Intel HEX file is opened 106 using a HEX file application. In a possible embodiment the content of the HEX file is encrypted 108 into encrypted text for security. The corresponding Nth part of the configuration data 34 is inserted 110 in the corresponding Nth part of the associated “candidate” track with an appendix ending mark. This is repeated 112,114 until all of the N parts of the configuration data 34 have been processed, and then the processed “candidate” tracks are then closed 116. Another data container of the “candidate” track may be the track tag. The track tag for each “candidate” track may have a character assigned that places each “candidate” track in the correct order. For example as shown in FIG. 3A, the track tag of each file is a character of the alphabet and the correct order is achieved when the “candidate” tracks are placed in alphabetical order. Similarly, the track tags may be assigned numbers, alpha-numeric characters, or other means to correctly identify the order.

FIG. 5 is a flow chart of a method 120 for installation of the processed “candidate” tracks on the base device 40 in accordance with an embodiment of the invention. The portable device 20 is docked 122 with the base device 40. In an embodiment, a user may trigger 124 firmware upgrading for the base device 40. As soon as a trigger is received either automatically or by the user's specific request, the update content configuration installation module 50 will search for tracks containing the identifying title tag, for example “Creative_msp_firmware” on the docked portable device 20. In another embodiment the installation module 50 searches for embedded update content in the processed media files upon receiving the processed media files from the portable device 20. If no tracks containing the tag identifying the embedded update content in the processed media files is found 128, then the application 42 runs 130 under routine operation 132. However, once a tag associated with the embedded update content in the processed media files is found 128, the processed tracks, for example with title tags “Creative_msp_firmware” album as the “now playing” content are chosen 134. The application 42 seeks 136 the Nth track and retrieves 136 the lyrics from the lyric tag or component of the media file. In an embodiment the text of the lyric if encrypted is decrypted into a useable format and written it into the corresponding address of the application 42, processor 44 and memory 46 of the base device 40. This process is repeated 142 until all of the N processed configuration data 34 files received are found and decrypted if necessary 140. Once completed and all N processed configuration data 34 files including the last track have been written to the corresponding address, the base device 40 is reboot 144 and the firmware is correspondingly upgraded. The rebooting may be arranged to perform automatically 144 upon writing the last of the Nth processed media files. Upon reboot, the firmware is upgraded and the updated and upgraded application 42 runs 146 under the updated program 132.

It will be appreciated that the process shown in FIG. 4 and FIG. 5 may be performed automatically and seamlessly without user intervention once the portable device 20 is docked to the base device 40. For example, in an embodiment the configuration data 34 may be placed on-line on the private or public network and the container module 30 of the portable device 20 is configured to automatically search for new configuration data 34 when connected to the content source 60. Alternatively, updates may be automatically sent to the portable device 20 from the content source 60. It will be appreciated that the sourcing of the configuration data 34 may be performed by the portable device 20 using other ways.

In certain embodiments, users may intervene and conduct aspects of the process manually. For example, a user may manually search the memory 26 of the portable device 20 for the media files with embedded update content. A user may manually select the track of the firmware identified by the track and title tags as the “now playing” content in the media player. This process may be manually repeated by the user for each track if the embedded update content is embedded in a number of media files. Upon completion of writing the final track of the media file with the embedded update content, the user may reboot the base device 40 to reconfigure, update and upgrade the system configuration or application 42 of the base device 40.

While embodiments of the invention have been described and illustrated, it will be understood by those skilled in the technology concerned that many variations or modifications in details of design or construction may be made without departing from the present invention.

1. A method for either updating or modifying a system configuration of a stand alone non-network connectible device comprising:
providing a portable device for communicating with the non-network connectible device;
generating a media file comprising embedded update content within a data container of the media file, the configuration content for either updating or modifying the system configurations of the non-network connectible device;
receiving the media file comprising the embedded configuration content at the non-network connectible device; and
installing the update content to either update or modify the system configuration of the non-network connectible device.

2. The method of claim 1 further comprises writing the embedded configuration content in the media file into a corresponding address within a memory of the non-network connectible device.

3. The method of claim 1 further comprises triggering by a user's action the installing the configuration content to update the system configuration of the non-network connectible device.

4. The method of claim 1 further comprises searching the portable device for a media file with the embedded configuration content, selecting and playing the media file with the embedded configuration content.

5. The method of claim 1 wherein the media file is a file with an associated information tag.

6. The method of claim 1 wherein the data container is an ID3 tag.

7. The method of claim 1 wherein generating the media file comprising embedded configuration content further comprises generating at least one media file, each media file having a portion of the embedded configuration content within a data container of each media file.

8. The method of claim 7 further comprises assigning to another track tag data container different characters to identify the correct order of the portion update content in the at least two media files.

9. The method of claim 1 wherein generating the media file comprising embedded configuration content further comprises naming another data container of the media file with a name representative of the update content.

10. The method of claim 9 wherein the another data container is a title tag.

11. The method of claim 1 further comprises connecting the portable device to a docking port of the non-network connectible device, the connection being either wired or wireless.

12. The method of claim 1 wherein the data container is a lyric tag.

13. The method of claim 1 further comprises formatting the configuration content in Intel HEX file format.

14. The method of claim 1 further comprises encrypting the configuration content.

15. The method of claim 1 wherein installing the configuration content to update the system configuration of the non-network connectible device further comprises rebooting the non-network connectible device.

16. The method of claim 1 wherein the media file is of the same type that is ordinarily received from the portable device in the routine operation of the stand alone non-network connectible device.
